(19) United States
(12) Patent Application Publication
(10) Pub. No.: US 2025/0050342 A1
(43) Pub. Date: Feb. 13, 2025

(54) DEVICE FOR COLLECTING, STORING AND DIVIDING SAMPLE

(71) Applicants: Dong Woo SON, Gyeonggi-do (KR); Hyun Sook LEE, Gyeonggi-do (KR)

(72) Inventors: Dong Woo SON, Gyeonggi-do (KR); Hyun Sook LEE, Gyeonggi-do (KR)

(21) Appl. No.: 18/294,119

(22) PCT Filed: Jul. 28, 2022
(86) PCT No.: PCT/KR2022/011131

§ 371 Date: Jan. 31, 2024

(30) Foreign Application Priority Data
Aug. 2, 2021 (KR) 10-2021-0101398

(51) Int. Cl. B01L 3/00

(52) U.S. Cl. CPC B01L 3/5029; B01L 2300/041; B01L 2300/047

(57) ABSTRACT

A device for collecting and storing, and dividing a sample. The device includes a hollow cylinder having open top and bottom ends, a top cap which is detachably coupled to the top end of the cylinder so as to block the open top portion of the cylinder, and at which a collection member disposed in the cylinder is mounted, and a bottom cap which is detachably coupled to the bottom end of the cylinder so as to block the open bottom portion of the cylinder, and which stores a reagent in a closed state, wherein the cylinder has, at the inner peripheral surface of the bottom end thereof, an opening part protruding toward the bottom cap so as to open a separation membrane for sealing the reagent.

### TECHNICAL FIELD

The present disclosure relates to a device for collecting, storing, and dividing a sample and, more particularly, to a swab device that collects specimens in various forms, allows immediate testing of the specimens, and allows for storage for a certain period of time to improve transportability.

### BACKGROUND ART

In general, health and environmental agencies, national food and drug administrations, hospitals, etc. often conduct specimen (or environmental: sample) sampling to accurately determine whether medical instruments, patient's skin, etc. are contaminated with harmful microorganisms, including pathogenic microorganisms or viruses, and the degree of contamination.

Food companies, etc. are also required to conduct specimen (or environmental sample) sampling to determine whether harmful bacteria are present in the food manufacturing environment, and the degree of contamination.

By immediately sending a sampled specimen to a testing center or laboratory for testing, the most accurate results can be obtained. However, if a sampled specimen cannot be tested immediately, it should be stored in an appropriate environment or transported to an appropriate place.

When a sampled specimen needs to be preserved and transported, appropriate reagents are required to keep the sampled specimen alive or active for a certain period of time. If additional culturing is necessary, reagents for this purpose are required. Meanwhile, depending on sampled specimens, there are cases where reagents are not required.

As such, depending on whether an environment is provided in which a sampled specimen can be immediately tested, a corresponding swab device and a swab method are selectively used. For example, when testing is performed by sampling a specimen at a laboratory, a swab device without reagents is used, and thus in this case, the specimen can be said to be collected using a dry swab method.

On the other hand, if a sampled specimen cannot be tested immediately and there is a need to preserve and transport the specimen, a swab device equipped with reagents is used. In this case, the specimen can be said to be collected using a wet swab method.

A swab device used in the dry swab method and the wet swab method as above may be commonly configured to have a collection member for specimen collection, a container with one end open to accommodate the collection member, and a cap that seals the container. At this time, when a reagent is contained in the container, the swab device can be said to be a swab device used in the wet swab method.

Depending on the location or environment where specimens are sampled, a swab method needs to be selectively determined and a corresponding swab device needs to be prepared. If an operator accidentally prepares a swab device that does not respond to the situation and location, a sampled specimen cannot be accurately tested. Moreover, since there are situations where various types of specimens must be sampled and sampling efficiency greatly depends on a swab method and collection surface, if a swab device or reagent suitable for the situation is not provided, a sampled specimen cannot be accurately tested, which is problematic.

Therefore, the present applicant has proposed the present disclosure to solve the above problems, and as a related art document, there is Korean Patent Application Publication No. 10-2021-0030549 “PIPETTE SWAB APPARATUS FOR MICROBIAL DETECTION”.

### DISCLOSURE

### Technical Problem

The present disclosure is intended to solve the above problems occurring in the related art. An objective of the present disclosure is to provide a swab device that selectively applies a dry swab method or a wet swab method considering various conditions including the type of a sampled specimen, the distance between the place where the specimen is sampled and a testing site, and the time when a test is conducted after the specimen is sampled.

### Technical Solution

In order to achieve the above mentioned objectives, there is provided a device for collecting, storing, and dividing a sample. The device includes: a hollow cylinder configured to have open top and bottom ends; a top cap which is detachably coupled to the top end of the cylinder to block an open top portion of the cylinder, and at which a collection member disposed in the cylinder is mounted; and a bottom cap which is detachably coupled to the bottom end of the cylinder to block an open bottom portion of the cylinder, and which stores a reagent in a closed state, wherein the cylinder may have, at an inner peripheral surface of the bottom end thereof, an opening part protruding toward the bottom cap to open a separation membrane for sealing the reagent.

In addition, the top cap may include: a tubular first coupling member having an inner peripheral surface coupled to an upper outer peripheral surface of the cylinder; and a second coupling member to be connected with the first coupling member and having a groove into which a longitudinal end of the collection member is inserted.

In addition, the device may further include: a protruding member protruding from a step formed at a connection point between the first coupling member and the second coupling member, and inserted into the open top portion of the cylinder and coming into contact with an upper inner surface of the cylinder when the first coupling member is coupled with an upper outer surface of the cylinder.

In addition, the bottom cap may include: a storage member that is inserted into the open bottom portion of the cylinder and provides an internal space where a reagent is stored;

In addition, a third coupling member is provided with an outer diameter larger than an outer diameter of the storage member, and coupled to a lower outer surface of the cylinder when the storage member is inserted into the open bottom portion of the cylinder; and a separation membrane that prevents the reagent stored in the storage member from leaking to the outside from the internal space.

In addition, the storage member may include: a discharge hole for discharging the reagent stored in the internal space to the outside; and an opening/closing member rotatably provided on the third coupling member to open and close the discharge hole.

In addition, the opening/closing member may have a flat bottom.

In addition, the opening part may include: a horizontal frame that protrudes from the inner peripheral surface of the bottom end of the cylinder toward a central axis of the cylinder; a vertical frame that is integrally connected to the horizontal frame and protrudes in a direction in which the storage member is disposed; and a blade member provided at a bottom end of the vertical frame.

In addition, the device may further include: a seating groove defined by the inner peripheral surface of the bottom end of the cylinder, the horizontal frame, and the vertical frame, wherein as the blade member cuts the separation membrane, an end of the storage member may be inserted into the seating groove and seated.

In addition, a length at which the vertical frame protrudes from the horizontal frame may be shorter than a length of the storage member or the third coupling member.

In addition, the first coupling member of the top cap and the third coupling member of the bottom cap may be respectively screw-coupled to the upper outer peripheral surface of the cylinder and a lower outer peripheral surface of the cylinder.

### Advantageous Effects

According to a swab device of the present disclosure, since a configuration is provided that allows a reagent to react with a specimen on a collection member by rotating a cylinder or a bottom cap, a user can easily apply a dry swab method or a wet swab method considering various conditions including the type of a sampled specimen, the distance between the place where the specimen is sampled and a testing site, and the time when a test is conducted after the specimen is sampled.

Furthermore, according to the swab device of the present disclosure, since a configuration is provided that allows a reagent reacted with a specimen to be discharged to the outside without the need to separate the bottom cap from the cylinder, a tester can easily perform testing work.

### DESCRIPTION OF DRAWINGS

FIG. 1 is a perspective view of a device for collecting, storing, and dividing a sample according to an embodiment of the present disclosure;

FIG. 2 is a cross-sectional view of the device for collecting, storing, and dividing a sample shown in FIG. 1;

FIG. 3 is an exploded cross-sectional view of the device for collecting, storing, and dividing a sample shown in FIG. 1;

FIG. 4 is a cross-sectional view showing a cylinder of the swab device shown in FIG. 2 in a lowered state;

FIG. 5 is a cross-sectional view of a top cap according to an embodiment of the present disclosure; and

FIG. 6 is a cross-sectional view of a bottom cap according to an embodiment of the present disclosure.

### BEST MODE

The advantages and features of the present disclosure and methods for achieving them will become clear by referring to the embodiments described in detail below in conjunction with the accompanying drawings.

However, the present disclosure is not limited to the embodiments disclosed below and will be implemented in various forms, and the embodiments are provided solely to ensure that the disclosure of the present disclosure is complete and to fully inform those skilled in the art of the scope of the invention. The present disclosure is defined solely by the scope of the claims.

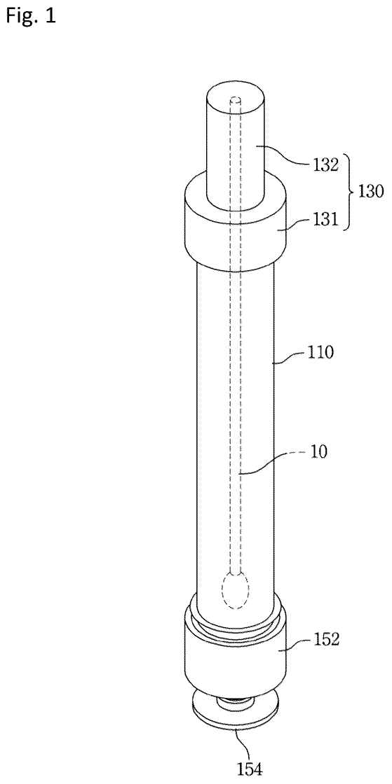

Hereinafter, a device for collecting, storing, and dividing a sample according to an embodiment of the present disclosure will be described in detail with reference to FIGS. 1 to 6. In describing the present disclosure, detailed descriptions of related known functions or configurations are omitted in order to not obscure the gist of the invention.

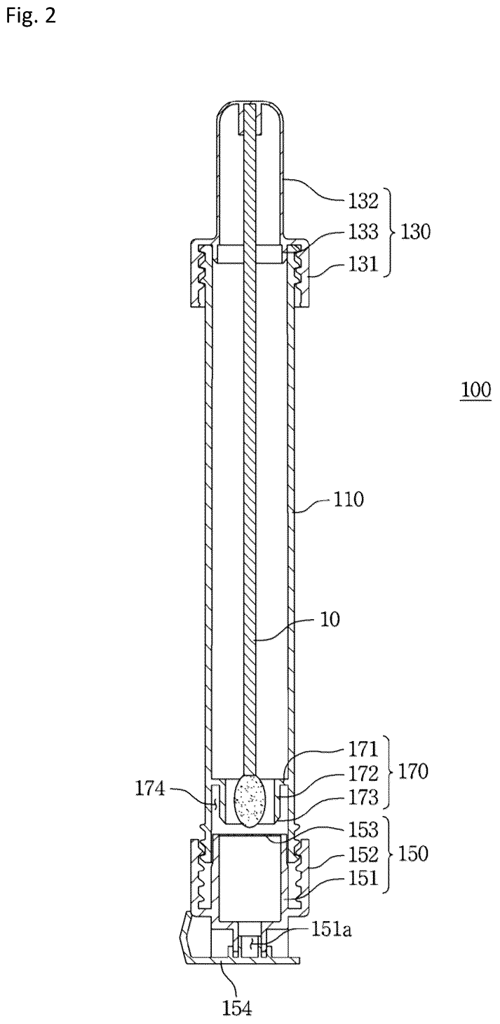

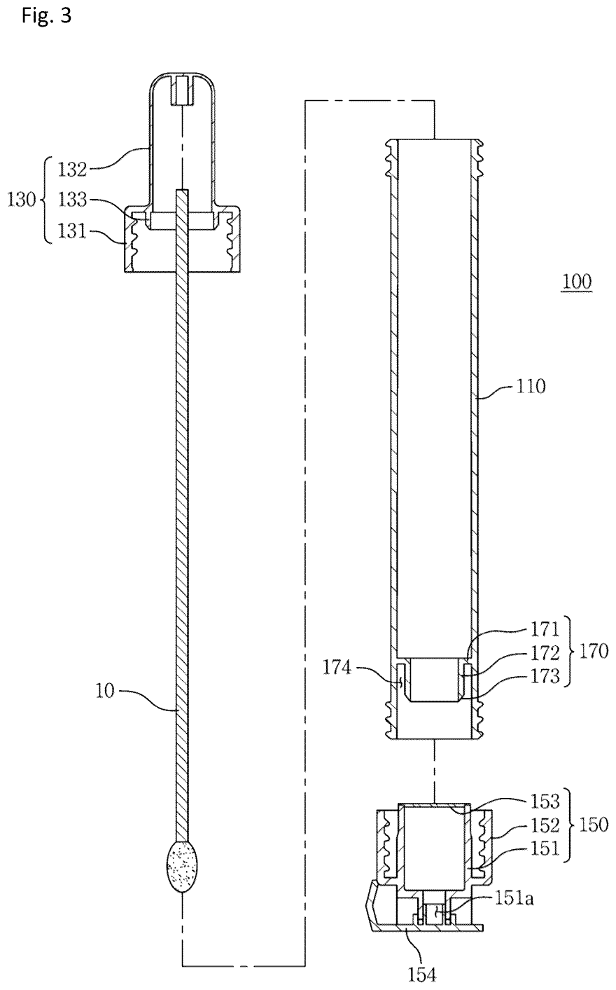

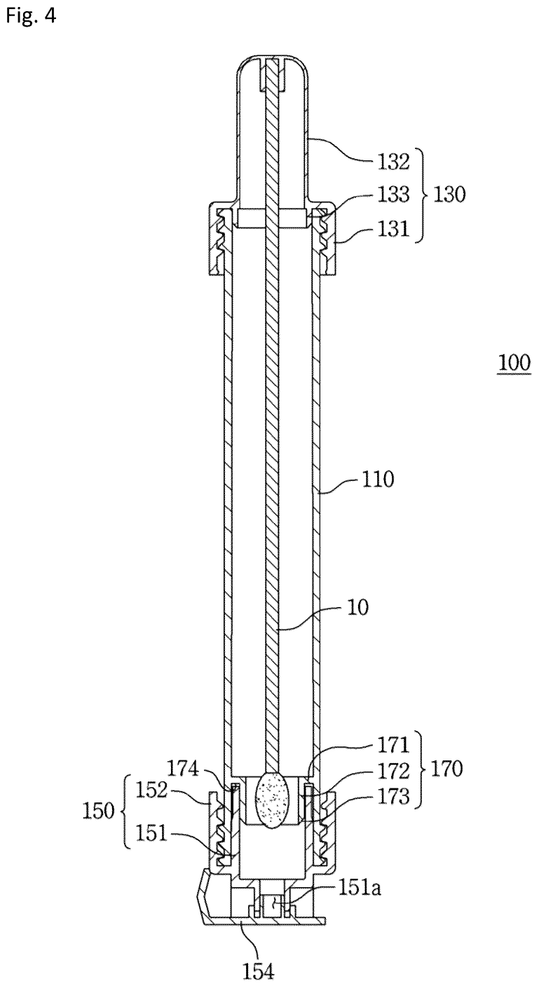

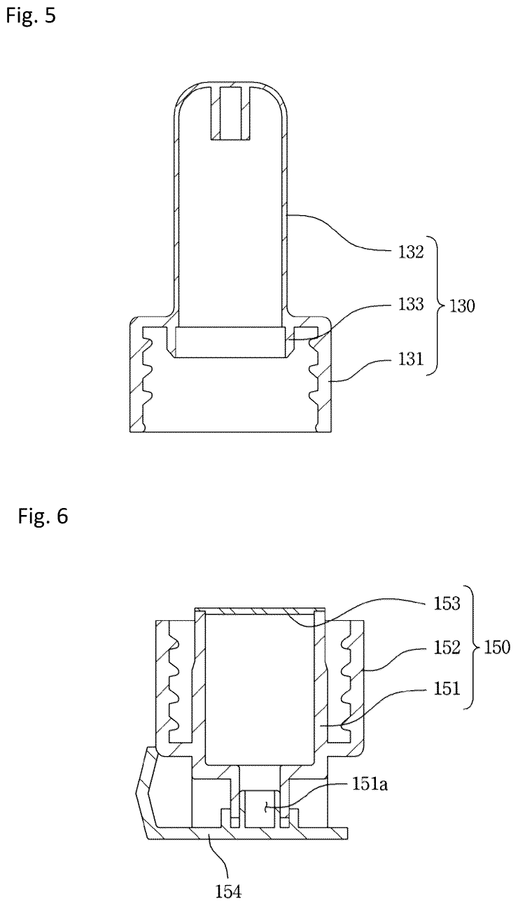

FIG. 1 is a perspective view of a device for collecting, storing, and dividing a sample according to an embodiment of the present disclosure; FIG. 2 is a cross-sectional view of the device for collecting, storing, and dividing a sample shown in FIG. 1; FIG. 3 is an exploded cross-sectional view of the device for collecting, storing, and dividing a sample shown in FIG. 1; FIG. 4 is a cross-sectional view showing a cylinder of the swab device shown in FIG. 2 in a lowered state; FIG. 5 is a cross-sectional view of a top cap according to an embodiment of the present disclosure; and FIG. 6 is a cross-sectional view of a bottom cap according to an embodiment of the present disclosure.

As shown in FIGS. 1 to 6, a device 100 for collecting, storing, and dividing a sample according to an embodiment of the present disclosure includes: a hollow cylinder 110 having open top and bottom ends; a top cap 130 which is detachably coupled to the top end of the cylinder 110 so as to block the open top portion of the cylinder 110, and at which a collection member 10 disposed in the cylinder is mounted; and a bottom cap 150 which is detachably coupled to the bottom end of the cylinder 110 so as to block the open bottom portion of the cylinder, and which stores a reagent in a closed state.

The cylinder 110 may have a predetermined length and is preferably made of a transparent material so that the interior may be visually inspected.

The top and bottom ends of the cylinder 110 are in an open state as described above.

The open top portion of the cylinder 110 may be blocked by the top cap 130, and the open bottom portion of the cylinder 110 may be blocked by the bottom cap 150.

The internal space of the cylinder 110 may be a space where the collection member 10 provided on the top cap 130 is disposed.

The top cap 130 may include: a tubular first coupling member 131 whose inner peripheral surface comes into contact with the upper outer peripheral surface of the cylinder 110; and a second coupling member 132 connected in communication with the first coupling member 131 and having a groove into which the longitudinal end of the collection member 10 may be inserted.

As shown in FIGS. 2 and 5, the first coupling member 131 may be fastened to the upper end of the cylinder 110 in a form that surrounds the upper end of the cylinder 110.

In the embodiment of the present disclosure, it is shown in the drawing that the first coupling member 131 and the upper end of the cylinder 110 are fastened to each other by a screw coupling method. That is, threaded parts that are screwed together are provided respectively on the inner peripheral surface of the first coupling member 131 and the outer peripheral surface of the upper end of the cylinder 110.

Therefore, the first coupling member 131 may be detachably fastened to the upper end of the cylinder 110 by screw coupling.

For reference, in the embodiment of the present disclosure, it is shown in the description and drawings that the first coupling member 131 and the upper end of the cylinder 110 are coupled to each other by a screw coupling method, but it is not limited thereto. For example, the first coupling member 131 and the upper end of the cylinder 110 may be coupled to each other using an interference fit method.

The second coupling member 132 is integrally connected with the first coupling member 131, as shown in FIGS. 2 and 5.

The second coupling member 132 forms a space that can communicate with the internal space partitioned by the first coupling member 131.

The second coupling member 132 may be a part that a user collecting a specimen holds by hand, and serves to support one end in the longitudinal direction of the collection member 10. Thus, a groove into which the longitudinal end of the collection member 10 is inserted is formed in the internal space defined by the second coupling member 132.

Meanwhile, the first coupling member 131 and the second coupling member 132 have different diameters. That is, the first coupling member 131 has an inner diameter and an outer diameter that are larger than the inner diameter and outer diameter of the second coupling member 132. Thus, a step is formed at the connection point between the first coupling member 131 and the second coupling member 132, and a protruding member 133 is formed on the step.

The protruding member 133: disposed at a predetermined distance from the inner surface of the first coupling member 131 and protrudes vertically downward in the shape of a tubular pipe.

When the first coupling member 131 is coupled with the upper outer surface of the cylinder 110, the protruding member 133 may be inserted into the open top portion of the cylinder 110 and come into contact with the upper inner surface of the cylinder 110 as shown in FIG. 2.

The protruding member 133 to be configured as described above serves to ensure that the top cap 130 is firmly coupled to the top end of the cylinder 110 and at the same time prevents the top cap 130 from moving unintentionally.

Meanwhile, the collection member 10, whose longitudinal end is connected to the first coupling member 131 of the top cap 130, is disposed in the internal space of the cylinder 110 when the top cap 130 is coupled to the top end of the cylinder 110 as shown in FIG. 2.

The bottom cap 150 may block the open bottom portion of the cylinder 110 and provide a reagent that reacts with a specimen on the collection member.

As shown in FIGS. 2, 3, and 6, the bottom cap 150 may include a storage member 151, a third coupling member 152, and a separation membrane 153.

The storage member 151 is inserted into the open bottom portion of the cylinder 110 and provides an internal space where a reagent may be stored.

The storage member 151 has the shape of a tubular pipe with an open top, and is partially inserted into the opening formed at the lower end of the cylinder 100 while storing a reagent. Meanwhile, the storage member 151 may further include a

discharge hole 151a for discharging a reagent stored in the internal space to the outside, and an opening/closing member 154 rotatably provided on the third coupling member 152 to open and close the discharge hole 151a.

The discharge hole 151a may be formed at the lower end of the storage member 151.

One side of the opening/closing member 154 may be rotatably connected to the third coupling member 152. The other side of the opening/closing member 154 is detachably coupled to the discharge hole 151a. To be specific, a stopper provided on the opening/closing member 154 may be inserted into the discharge hole 151a to block the discharge hole 151a. On the contrary, when the stopper of the opening/closing member 154 is separated from the discharge hole 151a, a reagent stored in the storage member 151 may be discharged to the outside through the discharge hole 151a.

For reference, it is preferable that the bottom surface of the opening/closing member 154 is flat. That is, as shown in FIGS. 2 to 4, it is preferable that the bottom surface of the opening/closing member 154 is flat when the stopper of the opening/closing member 154 is inserted into the discharge hole 151a to block the discharge hole 151a. This is to allow a user may easily set up the device 100 for collecting, storing, and dividing a sample on the floor, and to ensure that an opening part 170, which will be described later, may be easily inserted into the internal space of the storage member 151 when a user holds the cylinder 110 and pressurizes the cylinder 110 by touching the bottom surface of the opening/closing member 154 to the floor.

The third coupling member 152 is coupled to the lower outer surface of the cylinder 110 when the storage member 151 is inserted into the open bottom portion of the cylinder 110. The third coupling member 152 has an inner diameter and an outer diameter that are larger than the inner diameter and outer diameter of the storage member 151.

In addition, the third coupling member 152 may be fastened to the lower end of the cylinder 110 in a form that surrounds the lower end of the cylinder 110.

In the embodiment of the present disclosure, it is shown in the drawing that the third coupling member 152 and the lower end of the cylinder 110 are fastened to each other by a screw coupling method.

In the embodiment of the present disclosure, it is shown in the drawing that the third coupling member 152 and the lower end of the cylinder 110 are fastened to each other by a screw coupling method. That is, threaded parts that are screwed together are provided respectively on the inner peripheral surface of the third coupling member 152 and the outer peripheral surface of the lower end of the cylinder 110.

Therefore, the third coupling member 152 may be detachably fastened to the lower end of the cylinder 110 by screw coupling.

For reference, in the embodiment of the present disclosure, it is shown in the description and drawings that the third coupling member 152 and the lower end of the cylinder 110 are coupled to each other by a screw coupling method, but it is not limited thereto. For example, the third coupling member 152 and the lower end of the cylinder 110 may be coupled to each other using an interference fit method.

The separation membrane 153 serves to prevent a reagent stored in the storage member 151 from leaking out from the internal space formed by the storage member 151.

The separation membrane 153 may be implemented as a thin film or vinyl, and may block the open top of the storage member 151.

For reference, the separation membrane 153 may be connected to the top of the storage member 151 by heat fusion.

Meanwhile, the device 100 for collecting, storing, and dividing a sample according to the embodiment of the present disclosure further includes the opening part 170.

As shown in FIGS. 1 to 4, the opening part 170 may be provided on the lower inner peripheral surface of the cylinder 110 and has a shape that protrudes toward the bottom cap 150.

The opening part 170 may include: a horizontal frame 171 that protrudes from the inner peripheral surface of the lower end of the cylinder 110 toward the central axis of the cylinder 110; a vertical frame 172 that is integrally connected to the horizontal frame 171 and protrudes in the direction in which the storage member 151 is disposed; and a blade member 173 provided at the bottom of the vertical frame 172.

The horizontal frame 171 may be provided along the entire inner peripheral surface of the lower end of the cylinder 110, or may be provided on a portion of the inner peripheral surface of the lower end. In the embodiment of the present disclosure, the horizontal frame 171 is shown in the drawing as being provided along the entire inner peripheral surface of the lower end of the cylinder 110.

The vertical frame 172 has a hollow pipe shape, and the blade member 173 is provided at the lower end of the vertical frame 172. In addition, the vertical frame 172 has a length shorter than that of the storage member 151 or the third coupling member 152.

The blade member 173 serves to easily cut the separation membrane 153.

The opening part 170 serves to allow a reagent stored in the storage member 151 to be discharged to the top of the storage member 151 to react with a specimen on the collection member 10. Thus, it is preferable that the opening part 170 is provided at a position corresponding to the lower end of the collection member 10.

As shown in FIG. 4, the opening part 170 configured as above may be inserted into the internal space of the storage member 151 by tearing the separation membrane 153 depending on the degree to which the third coupling member 152 of the bottom cap 150 and the lower outer peripheral surface of the cylinder 110 are coupled to each other.

For example, as shown in FIG. 2, when the third coupling member 152 and the lower end of the cylinder 110 are partially coupled to each other, the opening part 170 may be disposed above the separation membrane 153 provided on the top of the storage member 151. At this time, the blade member 173 of the opening part 170 is in a non-contact state with the separation membrane 153. That is, when a portion of the threaded part formed on the inner peripheral surface of the third coupling member 152 and a portion of the threaded part formed on the lower end of the cylinder 110 are coupled to each other, the blade member 173 and the separation membrane 153 are in a non-contact state.

On the other hand, as shown in FIG. 4, when the entire threaded part formed on the inner peripheral surface of the third coupling member 152 and the entire threaded part formed on the lower end of the cylinder 110 are coupled to each other, the blade member 173 of the opening part 170 may cut the separation membrane 153. In addition, the vertical frame 172 and the lower end of the collection member 10 disposed inside the vertical frame 172 may be inserted into the internal space of the storage member 151.

Then, the reagent stored in the storage member 151 and the specimen on the collection member 10 may react.

Meanwhile, as shown in FIG. 2, a seating groove 174 defined by the inner peripheral surface of the lower end of the cylinder 110, and the horizontal frame 171 and the vertical frame 172 of the opening part 170 may be further included.

When the blade member 173 cuts the separation membrane 153, the seating groove 174 is a space where the upper end of the storage member 151 is inserted and seated as shown in FIG. 4.

Because the upper end of the storage member 151 is inserted into the seating groove 174, even if the device 100 for collecting, storing, and dividing a sample is stored or transported for a long time, the bottom cap 150 may be prevented from being separated or moved from the bottom of the cylinder 110 due to external force.

The device 100 for collecting, storing, and dividing a sample according to the embodiment of the present disclosure provides a configuration that allows a reagent to react with a specimen on the collection member by rotating the cylinder 110 or the bottom cap 150. Thus, a user may easily apply a dry swab method or a wet swab method considering various conditions including the type of a sampled specimen, the distance between the place where the specimen is sampled and a testing site, and the time when a test is conducted after the specimen is sample.

Although specific embodiments according to the present disclosure have been described so far, various modifications are possible without departing from the scope of the present disclosure.

For example, a reagent stored in the storage member 151 may be liquid or powder. If a reagent stored in the storage member 151 is a powder, water or a liquid reactant that reacts with the powder reagent may be stored in the internal space of the cylinder 110.

Therefore, the scope of the present disclosure should not be limited to the described embodiments, but should be determined by the scope of the patent claims described below as well as their equivalents.

### INDUSTRIAL APPLICABILITY

The present disclosure may be applied and sold in a variety of industrial fields that use component testing, material testing, and measuring and analytical instruments.

1. A device for collecting and storing a sample, the device comprising:
a hollow cylinder comprising open top and bottom ends;
a top cap which is detachably coupled to the top end of the cylinder to block an open top portion of the cylinder, and at which a collection member disposed in the cylinder is mounted; and
a bottom cap which is detachably coupled to the bottom end of the cylinder to block an open bottom portion of the cylinder, and which stores a reagent in a closed state,
wherein the cylinder includes, at an inner peripheral surface of the bottom end thereof, an opening part protruding toward the bottom cap to open a separation membrane for sealing the reagent.

2. The device of claim 1, wherein the top cap comprises:
a tubular first coupling member having an inner peripheral surface coupled to an upper outer peripheral surface of the cylinder; and
a second coupling member connected in communication with the first coupling member and having a groove into which a longitudinal end of the collection member is inserted.

3. The device of claim 2, further comprising:
a protruding member protruding from a step formed at a connection point between the first coupling member and the second coupling member, and inserted into the open top portion of the cylinder and coming into contact with an upper inner surface of the cylinder when the first coupling member is coupled with an upper outer surface of the cylinder.

4. The device of claim 2, wherein the bottom cap comprises:
a storage member that is inserted into the open bottom portion of the cylinder and provides an internal space where a reagent is stored;
a third coupling member provided with an outer diameter larger than an outer diameter of the storage member, and coupled to a lower outer surface of the cylinder when the storage member is inserted into the open bottom portion of the cylinder; and
a separation membrane that prevents the reagent stored in the storage member from leaking to the outside from the internal space.

5. The device of claim 4, wherein the storage member comprises:
a discharge hole for discharging the reagent stored in the internal space to the outside; and
an opening/closing member rotatably provided on the third coupling member to open and close the discharge hole.

6. The device of claim 5, wherein the opening/closing member includes a flat bottom.

7. The device of claim 4, wherein the opening part comprises:
a horizontal frame that protrudes from the inner peripheral surface of the bottom end of the cylinder toward a central axis of the cylinder;
a vertical frame that is integrally connected to the horizontal frame and protrudes in a direction in which the storage member is disposed; and
a blade member provided at a bottom end of the vertical frame.

8. The device of claim 7, further comprising:
a seating groove defined by the inner peripheral surface of the bottom end of the cylinder, the horizontal frame, and the vertical frame,
wherein as the blade member cuts the separation membrane, an end of the storage member is inserted into the seating groove and seated.

9. The device of claim 7, wherein a length at which the vertical frame protrudes from the horizontal frame is shorter than a length of the storage member or the third coupling member.

10. The device of claim 4, wherein the first coupling member of the top cap and the third coupling member of the bottom cap are respectively screw-coupled to the upper outer peripheral surface of the cylinder and a lower outer peripheral surface of the cylinder.
